(19) United States
(12) Patent Application Publication
(10) Pub. No.: US 2009/0059065 A1
(43) Pub. Date: Mar. 5, 2009

(54) INTERPOLATIVE FRAME GENERATING APPARATUS AND METHOD

(75) Inventor: Masaya Yamasaki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/201,118

(22) Filed: Aug. 29, 2008

(30) Foreign Application Priority Data
Aug. 31, 2007 (JP) 2007-225889

(51) Int. Cl. H04N 7/01

(52) U.S. Cl. 348/441; 348/E07.003

(57) ABSTRACT

According to one embodiment, there is disclosed an interpolative frame generating apparatus includes a first operation unit performing block matching processing with respect to a fixed-length first block, and based on the processing result, calculating a size of a second block, a second operation unit performing block matching processing using a second block having the size calculated in the prior interpolated frame processing cycle, and a third operation unit selecting one from a plurality of motion vector candidates based on the motion vector of the second block calculated in the prior interpolated frame processing cycle when a plurality of motion vector candidates is detected in the block matching processing of the first block.

### CROSS-REFERENCE TO RELATED APPLICATIONS

This application is based upon and claims the benefit of priority from Japanese Patent Application No. 2007-225889, filed Aug. 31, 2007, the entire contents of which are incorporated herein by reference.

### BACKGROUND

1. Field

One embodiment of the present invention relates to an interpolative frame generating apparatus for generating and inserting an interpolated frame between continuous frame images. In particular, the present invention relates to an interpolative frame generating apparatus for performing block matching using a variable-length block.

2. Description of the Related Art

When moving images are displayed on a liquid crystal display (LCD), the LCD displays frame images (hereinafter simply referred to as “frames”) at a rate of 60 frames/second, for example. The frames are sequential scanning images obtained by processing an interlace signal of 60 fields/second. In other words, the LCD continues to display one frame for 1/60 second.

When such images displayed on LCDs are viewed, an image of a prior frame is left as persistence of vision for viewer's eyes. For this reason, there are cases where a moving object in the images appears blurred, or movement of the object appears unnatural. Such a phenomenon appears more conspicuously on large screens.

Jpn. Pat. Appln. KOKAI Publication No. 2005-6275 discloses the following method to prevent the foregoing blurring of moving images. According to the method, an interpolated frame is inserted between two continuous two frames to display moving images.

However, according to the technique disclosed in the foregoing Publication, block matching is performed using a fixed-length block. For this reason, proper matching processing is not performed with respect to images including a periodical repeating pattern.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of an interpolative frame generating apparatus according to one embodiment of the present invention;

FIG. 2 is a view to explain one example of block matching processing of the interpolative frame generating apparatus;

FIG. 3 is a view showing one example of a variable-length block generated from a fixed-length block by the interpolative frame generating apparatus;

FIG. 4 is a view showing one example of matching processing using a fixed-length block of the interpolative frame generating apparatus;

FIG. 5 is a view showing one example of matching processing using a variable-length block of the interpolative frame generating apparatus;

FIG. 6 is a graph showing SAD characteristic by block matching processing using fixed- and variable-length blocks of the interpolative frame generating apparatus;

FIG. 7 is a flowchart to explain three-stage operations of the interpolative frame generating apparatus;

FIG. 8 is a block diagram showing the first configuration of an operation circuit using a plurality of buffers in an interpolative frame generating apparatus;

FIG. 9 is a block diagram showing the second configuration of an operation circuit using a single buffer in an interpolative frame generating apparatus;

FIG. 10 is a view showing one example of handling frame images by the operation circuit using a plurality of buffers in an interpolative frame generating apparatus;

FIG. 11 is a view showing one example of handling frame images by the operation circuit using a single buffer in an interpolative frame generating apparatus;

FIG. 12 is a flowchart to explain a first operation of the interpolative frame generating apparatus;

FIG. 13 is a flowchart to explain a second operation of the interpolative frame generating apparatus; and

FIG. 14 is a flowchart to explain a third operation of the interpolative frame generating apparatus.

### DETAILED DESCRIPTION

Various embodiments according to the invention will be described hereinafter. In general, according to one embodiment of the invention, there is provided an interpolative frame generating apparatus for generating an interpolated frame image inserted between continuous frame images, comprising: a first operation unit performing block matching processing with respect to a first block having a fixed size between the continuous frame image, and based on the result, calculating a size of a second block larger than the first block; a second operation unit performing block matching processing between the continuous frame image using the second block in accordance with the size calculated by the first operation unit in a prior interpolated frame processing cycle to calculate a motion vector; a third operation unit outputting a motion vector when one motion vector is detected based on the result of performing block matching processing with respect to the first block, and selecting and outputting one motion vector candidate from a plurality of motion vector candidates based on the motion vector obtained related to the second block in the prior interpolated frame processing cycle when a plurality of motion vector candidates is detected; and a generator producing an interpolated frame image based on the motion vector output by the third operation unit.

A large block is properly variable with respect to an image including a periodical repeating pattern, and thereby, it is possible to make high-accurate motion vector detection in accordance with an image pattern. In addition, the operation result used for the operation processing is acquired from a foregoing processing cycle of the interpolated frame. Thus, the total amount of required buffer is reduced.

An embodiment of the invention will be hereinafter described with reference to the accompanying drawings.

### CONFIGURATION OF INTERPOLATIVE FRAME GENERATING APPARATUS ACCORDING TO ONE EMBODIMENT OF THE INVENTION

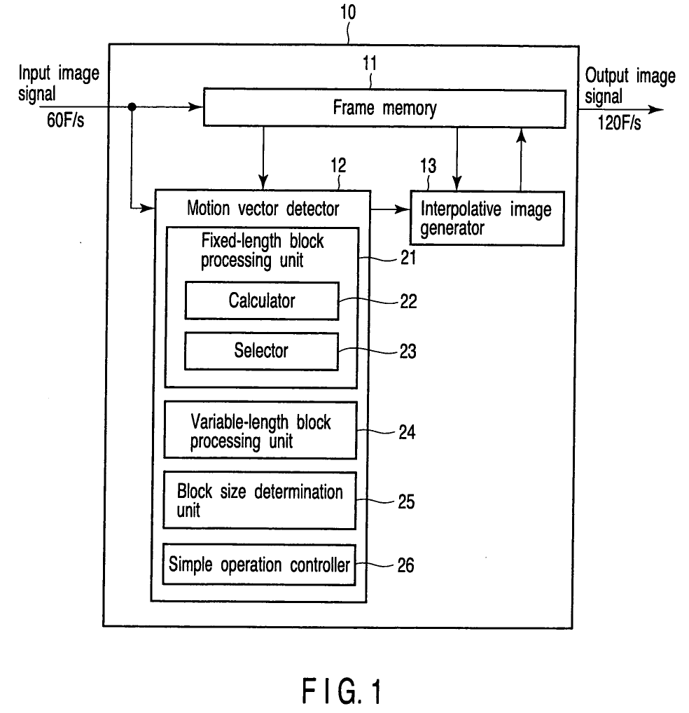

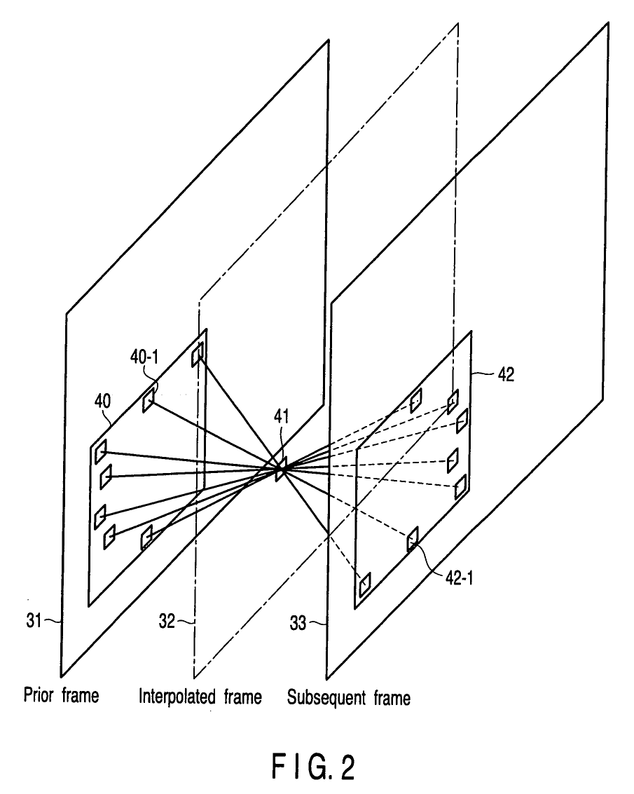

The configuration of an interpolative frame generating apparatus according to one embodiment of the invention will be described referring to the drawings. FIG. 1 is a block diagram showing the configuration of an interpolative frame generating apparatus according to one embodiment of the present invention. FIG. 2 is a view to explain one example of block matching processing of the interpolative frame generating apparatus.

As shown in FIG. 1, an interpolative frame generating apparatus 10 according to one embodiment of the present invention includes a frame memory 11, a motion vector detector 12 and an interpolative image generator 13. More specifically, the frame memory 11 is supplied with an input image signal from an input terminal. The motion vector detector 12 is supplied with an input image signal from the input terminal and the frame memory 11. The interpolative image generator 13 is supplied with a motion vector from the motion vector detector 12 and an input image signal from the frame memory 11 to generate an interpolated image.

The motion vector detector 12 includes a fixed-length block processing unit 21, a variable-length block processing unit 24, a block size determination unit 25 and a simple operation controller 26. The simple operation controller 26 makes an operation using the operation result of the prior interpolated frame processing cycle. The fixed-length block processing unit 21 includes a calculator 22 and a selector 23.

As seen from FIG. 2, the interpolative frame generating apparatus 10 having the foregoing configuration generates and inserts an interpolated frame 32 between a prior frame 31 and a subsequent frame 33. Then, the apparatus 10 converts a 60 F/s input signal to a 120 F/s signal. In this case, the interpolative image generator 13 generates an interpolated frame 32 based on a motion vector detected by the motion vector detector 12.

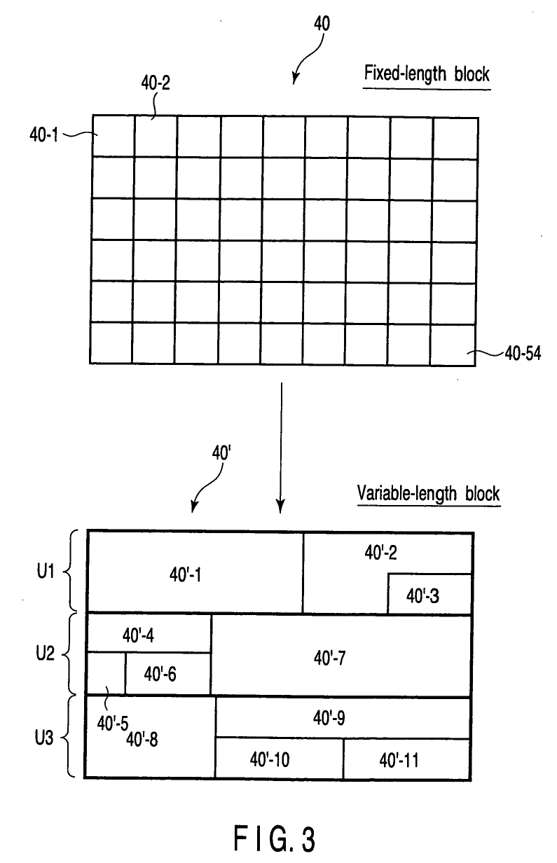

Specifically, the motion vector detector 12 executes block matching processing between the prior frame 31 and the subsequent frame 33 based on fixed-length blocks 40-1, 40-2, . . . , 40-54 shown in FIG. 3, and thus, detect a motion vector. In addition, the motion vector detector 12 partially generates a variable-length block, and executes block matching processing based on the variable-length block. In accordance with the result, the accuracy of the block matching processing result of the fixed-length block is improved.

The simple operation controller 26 controls an operation using the operation result of the interpolated frame in the foregoing operation. This serves to reduce an operation pixel buffer capacity included in the simple operation controller to about ⅓ of the conventional case. The details will be explained below referring to the drawings.

### <Block Matching Processing of Fixed-Length Block and Variable-Length Block>

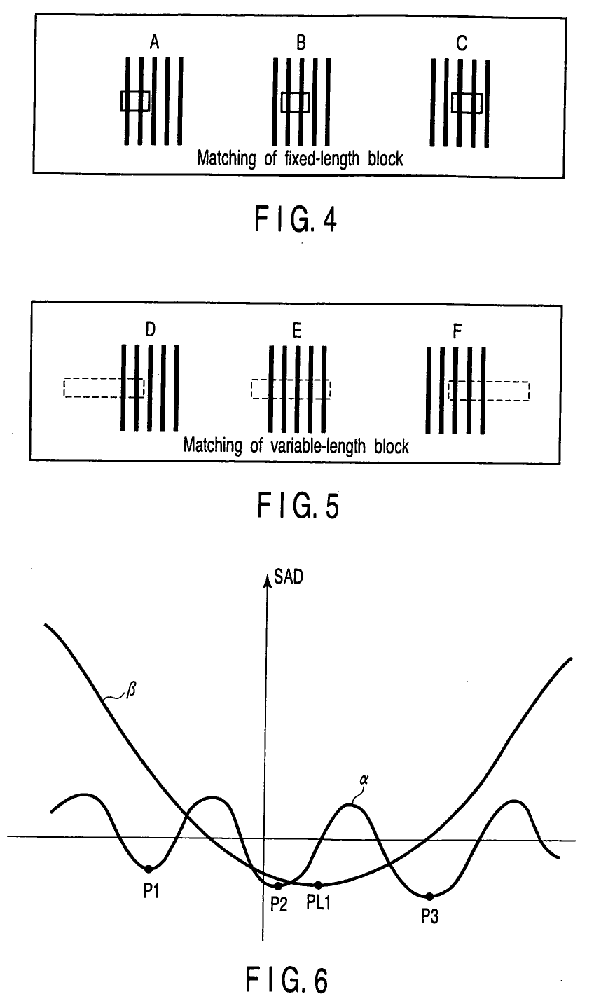

Block matching processing of fixed-length block and variable-length block will be described referring to the drawings. FIG. 3 shows one example of a variable-length block generated from a fixed-length block by the interpolative frame generating apparatus 10. FIG. 4 is a view showing one example of matching processing using the fixed-length block of the interpolative frame generating apparatus 10. FIG. 5 is a view showing one example of matching processing using the variable-length block of the interpolative frame generating apparatus 10. FIG. 6 is a graph showing a SAD characteristic by block matching processing using fixed- and variable-length blocks of the interpolative frame generating apparatus 10.

Block Matching Processing

According to the block matching processing, detection is made that an image block having a predetermined size in a certain frame matches with any image block of the subsequent frame.

As illustrated in FIG. 2, according to the foregoing block matching processing, an insertion position of an interpolated image block 41 on an interpolated frame 32 is determined as a center. Then, image blocks positioned at point symmetry on the prior and subsequent frames 31 and 33 holding the frame 32 are compared with each other every pixel to calculate the sum of absolute difference (SAD). The SAD is a value obtained in the following manner. Specifically, in the point symmetry positioned image blocks (e.g., block 40-1 and 42-1), the difference between the mutually corresponding positioned pixels is calculated. Thereafter, the difference of the image block is accumulated. An image block pair having the minimum SAD in search ranges 40 and 42 is detected as the most similar image block pair.

If the most similar image block pair is image blocks 40-1 and 42-1 as described above, a vector from the image block 40-1 to the image block 42-1 is determined as a motion vector of the interpolated image block 41. The motion vector is detected as direction and distance in which the image block moves between the prior and subsequent frames. In this way, the interpolated image block 41 in the interpolated frame 32 is generated based on the motion vector and image data of the most similar image blocks 40-1 and 42-1.

As described above, the interpolative image generator 13 generates an interpolated frame image based on the motion vector between frames detected by the motion vector detector 12. A new interpolated frame positioned between input frames is generated using a motion vector of each image block. The interpolated frame is inserted between two input frames, and thereby, the number of frames is increased to display a naturally visible motion image.

Fixed-Length Block (Small Block) and Variable-Length Block (Large Block)

According to the block matching processing, detection accuracy of the motion vector is improved in the following manner. Specifically, variable-length blocks 40′-1, 40′-2, . . . having a variable block size shown in the under portion of FIG. 3 are used in addition to fixed-length blocks having a fixed block size shown in the upper portion of FIG. 3.

In other words, as seen from FIG. 4, when vertical-striped periodical patterns exist in an input frame, it is impossible to estimate an accurate motion vector of a fixed-length image block in the periodical pattern even if the SAD value only is used. In the case of FIG. 4, the vertical strips come to rest. Therefore, a SAD value a of the fixed-length block shown in FIG. 6 has a plurality of the minimum values P1, P2 and P3 (motion vector candidates). As a result, the motion vector is not specified.

As depicted in FIG. 5, matching processing is performed using a sufficiently large variable-length block with respect to the vertical-striped periodical pattern. The block matching processing using the variable-length block is performed, and thereby, a SAD value β of the variable-length block shown in FIG. 6 has only one minimum value PL1. Thus, the motion vector is easy to be detected.

Therefore, according to an interpolative frame generating method of detecting the motion vector using block matching, using at least two or more blocks having different size is effective. Usually, a motion vector detected using a smaller block of two or more blocks is employed. When vector detection is made using the small block, if a plurality of motion vector candidates is detected, the following operation is carried out. Specifically, reference is made to a motion vector detected using a large block to select a true motion vector from the motion vector candidates.

According to the graph of FIG. 6, it is determined that the minimum value P2 nearest to the minimum value PL1 of the SAD value β of the variable-length block (large block) is a true motion vector. In this way, it is possible to improve a detection accuracy of the motion vector of an image including a periodical pattern.

Incidentally, the foregoing technique is disclosed in the prior application (Jpn. Pat. Appln. Publication No. 2008-35404, filed on Jul. 31, 2006).

Determination of Variable-Length Block Size

The following is an explanation of the standard of determining a proper block size when a motion vector of the variable-length block (large block) is detected.

As shown in FIG. 4, small blocks A, B and C are not distinguished from each other because the same image only is included in a rectangular area. As seen from FIG. 5, there are shown large blocks D, E and F having a size ranging over the periodical repeating pattern width. In these blocks D, E and F, an image included in a rectangular area is different; therefore, it is possible to uniquely detect a correct motion vector.

Thus, it is desired as a proper size to satisfy the following condition. Specifically, the block size when the motion of the large block is detected has a sufficient size, which is not confused by the periodical repeating pattern. In addition, the block size is not too large wastefully, so that a plurality of objects each having some motion comes into the block.

According to a method of detecting the periodical repeating pattern width, “an area where some motion vector candidates are generated” is detected. Based on the width of the area, “a size of a variable-length block (large block)” is determined.

Thus, the following determination method is preferable; however, the present invention is not limited to this method.

“Area where some motion vector candidates are generated”≈“Size of variable-length block (large block)”

Or,

“Area where some motion vector candidates are generated” ≈“Size of variable-length block (large block)”+a (constant)

Incidentally, the technique similar to this technique is disclosed in the prior application (Jpn. Pat. Appln. Publication No. 2008-147951, filed on Dec. 8, 2006).

### <Operation Control Method of Interpolative Frame Generating Apparatus>

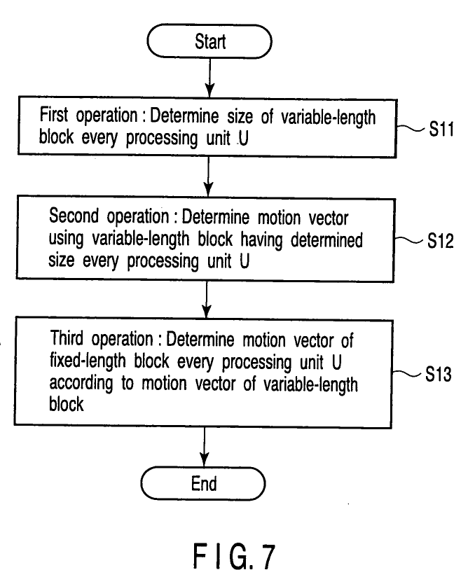

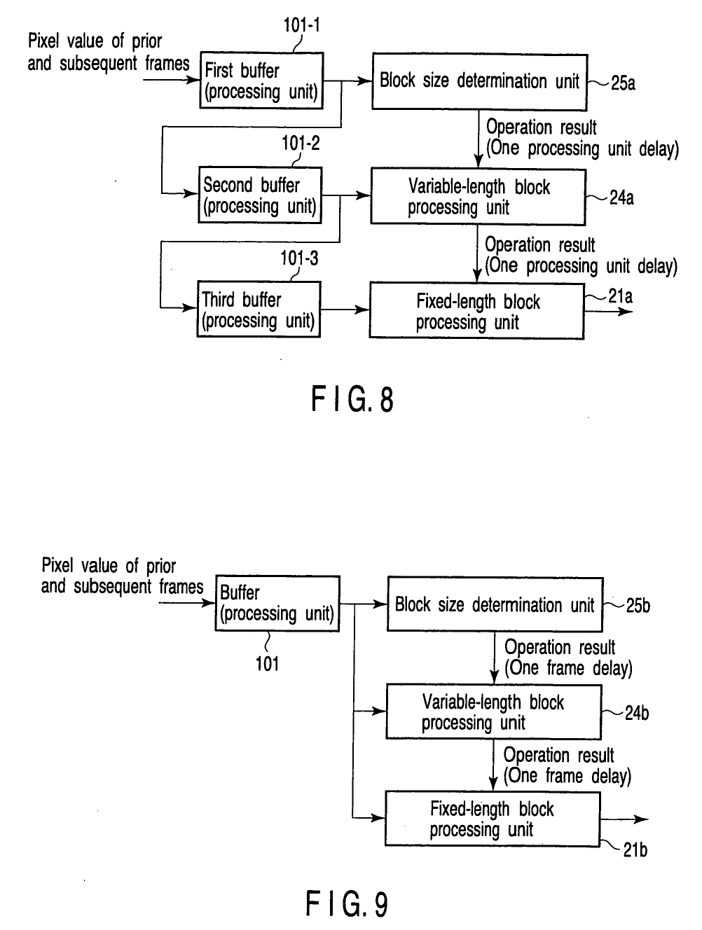

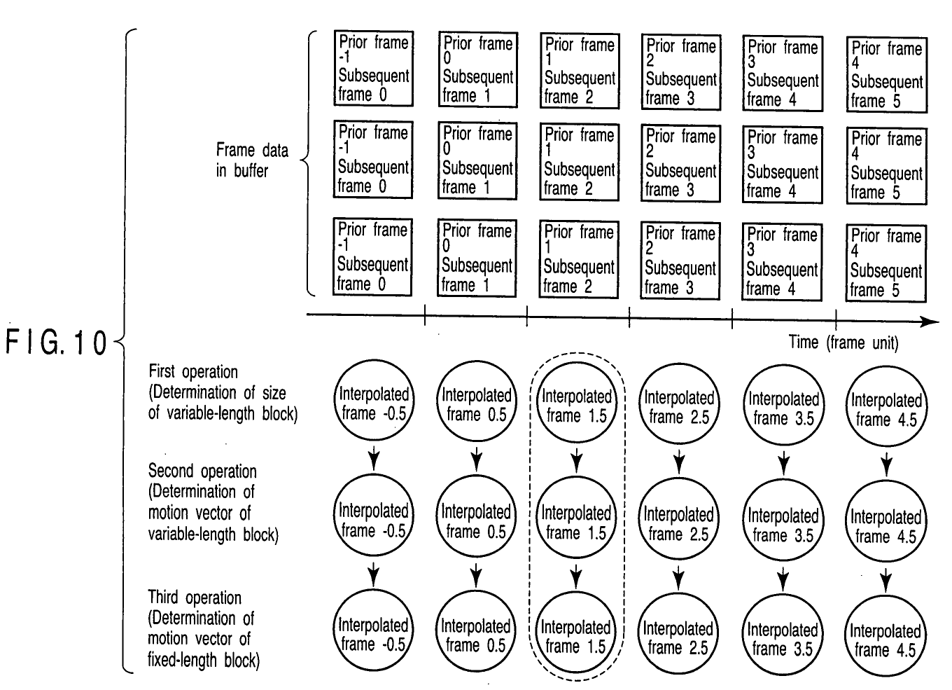

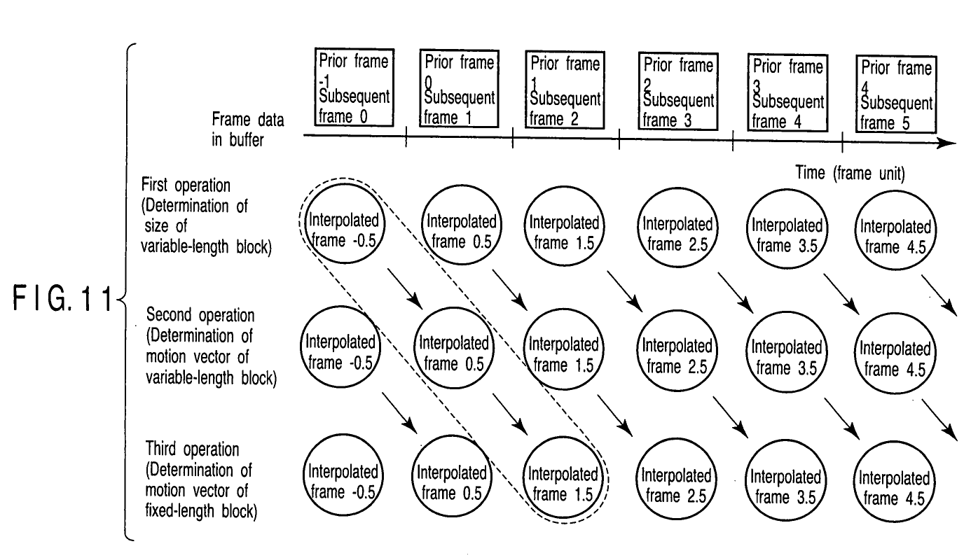

An operation control method of the interpolative frame generating apparatus 10 will be explained below with reference to a flowchart. FIG. 7 is a flowchart to explain one example of three-stage operations of the interpolative frame generating apparatus 10. FIG. 8 is a block diagram showing the first configuration of an operation circuit using a plurality of buffers in an interpolative frame generating apparatus. FIG. 9 is a block diagram showing the second configuration of an operation circuit using a single buffer in an interpolative frame generating apparatus. FIG. 10 is a view showing one example of handling frame images by the operation circuit using a plurality of buffers in an interpolative frame generating apparatus. FIG. 11 is a view showing one example of handling frame images by the operation circuit using a single buffer in an interpolative frame generating apparatus.

Three-Stage Operations

As seen from the flowchart of FIG. 7, the interpolative frame generating apparatus 10 executes three-stage operations to determine a motion vector.

According to a first operation, the motion vector detector 12 determines the size of the variable-length block (step S11). According to a second operation, the motion vector detector 12 searches a motion vector using the variable-length block having the determined size (step S12). Finally, according to a third operation, the motion vector detector 12 determines a motion vector of a small block according to the motion vector of the variable-length block (step S13). Thereafter, based on the determined motion vector, the interpolative image generator 13 generates an interpolated frame image, and then, inserts it between the prior and subsequent frame images.

(First Motion Vector Detection)

When the second operation is carried out using the first operation result, and the third operation is carried out using the second operation result, there is no margin of processing timing. For this reason, as shown in FIG. 8, three operation buffers 101-1, 101-2 and 101-3 are required as a frame image buffer. In this case, a block size determination 25a executes the first operation, a variable-length block processing unit 24a executes the second operation, and a fixed-length block processing unit 21a executes the third operation.

Specifically, each pixel value buffer of the prior and subsequent frames 31 and 33 is required in accordance with the foregoing three operations. The total buffer size is determined according to the following condition.

3*2*1920*128*30=44236800 bits
Full-HD (Horizontal direction 1920 pixels×Vertical direction 1080 pixels)
Small block size has (Horizontal direction 64 pixels×Vertical direction 16 pixels)
Vector search range of small block is (Horizontal direction 256 pixels×Vertical direction 128 pixels)
Motion vector per small block is a 16-bit signal
30-bit signal per pixel

According to the first vector detection, as shown by the broken line of FIG. 10, in one frame processing cycle, the buffer waits the first operation result, executes the second operation using the operation result, and then, executes the third operation using the second operation result. Thus, time margin for supplying the operation result is delay time only equivalent to one processing unit U, which is shown by a processing unit U of FIG. 3.

In FIG. 10, frame data in each buffer shown by a square are shown as “prior −1, subsequent 0”, “prior 0, subsequent 1”, “prior 1, subsequent 2”, “prior 2, subsequent 3”, “prior 3, subsequent 4”, and “prior 4, subsequent 5”. The foregoing frame data are supplied to an operation circuit for interpolative frame processing. More specifically, the “prior −1, subsequent 0” denotes −1 frame image data of the prior frame and 0 frame image data of the subsequent frame. The “prior 0, subsequent 1” denotes 0 frame image data of the prior frame and the first frame image data of the subsequent frame. The “prior 1, subsequent 2” denotes the first frame image data of the prior frame and the second frame image data of the subsequent frame. The “prior 2, subsequent 3” denotes the second frame image data of the prior frame and the third frame image data of the subsequent frame. The “prior 3, subsequent 4” denotes the third frame image data of the prior frame and the fourth frame image data of the subsequent frame. The “prior 4, subsequent 5” denotes the fourth frame image data of the prior frame and the fifth frame image data of the subsequent frame.

In FIG. 10, “Interpolated frame −0.5, Interpolated frame 0.5, Interpolated frame 1.5, Interpolated frame 2.5, Interpolated frame 3.5 and Interpolated frame 4.5, which are shown by a circle each denote an interpolative frame processing operation result. For example, the interpolated frame 0.5 denotes an operation result for processing the intermediate interpolated frame n+0.5 using pixel data having the prior frame n and the subsequent frame n+1.

The simple operation controller 26 stores the operation result from the block size determination unit 25 in a built-in memory, and thereafter, supplies it to the variable-length block processing unit 24. The controller 26 further stores the operation result from the variable-length block processing unit 24 in a built-in memory, and thereafter, supplies it to the fixed-length block processing unit 21. Thus, as shown in FIG. 8, the buffer requires a specific operator (25a, 24a, 21a) to correspond frame data in buffer to a position of the same processing unit U on the same interpolated frame.

(Second Motion Vector Detection)

The following method is given to solve the a problem of the buffer amount related to the foregoing three-stage operations executed in one frame processing cycle. According to the method, preferably, the operation is executed using the operation result before one or two frames.

In FIG. 9, a variable-length block processing unit 24b detects a motion vector using a variable-length block having a size determined by the prior interpolated frame processing cycle. A fixed-length block processing unit 21b determines a motion vector of a fixed-length block according to the motion vector of the variable-length block acquired by the prior interpolated frame processing cycle. A buffer 101 is commonly used as the buffer stored with frame images because the operation result acquired by the prior interpolated frame processing cycle.

According to the operation, as seen from FIGS. 9 and 11, the pre-stage operation result used for the operation does not acquire from the same interpolative frame processing cycle. The operation result is acquired from the prior interpolated frame processing cycle. Therefore, as shown by the broken line in FIG. 11, the second operation is carried out using the first operation result (size of variable-length block) of the prior interpolated frame processing cycle. Then, the third operation (determination of the motion vector of the fixed-length block) is carried out using the second operation result (motion vector of variable-length block) of the prior interpolated frame processing cycle.

As a result, delay time equivalent to one frame is secured as time for supplying the operation result. The simple operation controller 26 stores the operation result from the block size determination unit 25 in a built-in memory, and thereafter, supplies it to the variable-length block processing unit 24 in the next interpolative frame processing cycle. The controller 26 further stores the operation result from the variable-length block processing unit 24 in a built-in memory, and thereafter, supplies it to the fixed-length block processing unit 21 in the next interpolative frame processing cycle. Therefore, time margin is sufficiently taken. In this way, the buffer is made correspondent to the same processing unit U position on different frame as seen from FIG. 9, and thereby, used in common to each operator (25b, 24b, 21b).

According to this embodiment, the operation result of o frame image data and the operation result of −1 frame image are used for the first frame image operation. The use of the foregoing substitution operation result results from the following reason.

Specifically, there is a high possibility that the same pattern exists when interpolated frames before one and two are generated except time when scene is changed. Thus, as depicted in the lower portion of FIG. 10, the first to third operations are all executed when one interpolated frame is generated, but dispersed when a plurality of interpolated frames are generated. In addition, the capacity of the operation result when interpolated frames before one and two are generated is considerably smaller than the capacity of pixel value buffer used for generating one interpolated frame.

Therefore, the operation result obtained by the prior interpolated frame processing cycle is used, and thereby, the buffer capacity is reduced to ⅓ of the conventional case as a result. As is evident from FIG. 9, the pixel value buffer is reduced to one buffer from three buffers shown in FIG. 8. Thus, the capacity required for the memory of the simple operation controller 26 for transferring the operation result is considerably smaller than the pixel value buffer.

The total buffer size is determined according to the same condition as described before.

1*2*1920*128*30+(1920/64)*(1080/16)*1+(1920/64)*(1080/16)*16=14780280 bits

The foregoing bit value is reduced to about ⅓ as compared with the configuration shown in FIG. 8. The second term of the foregoing addition is required to the first operation result, and the third term thereof is required to the second operation result. However, these terms of the addition are so disregard-able small as compared with the first term of the pixel value buffer itself.

(Explanation of Each Operation Using Flowchart)

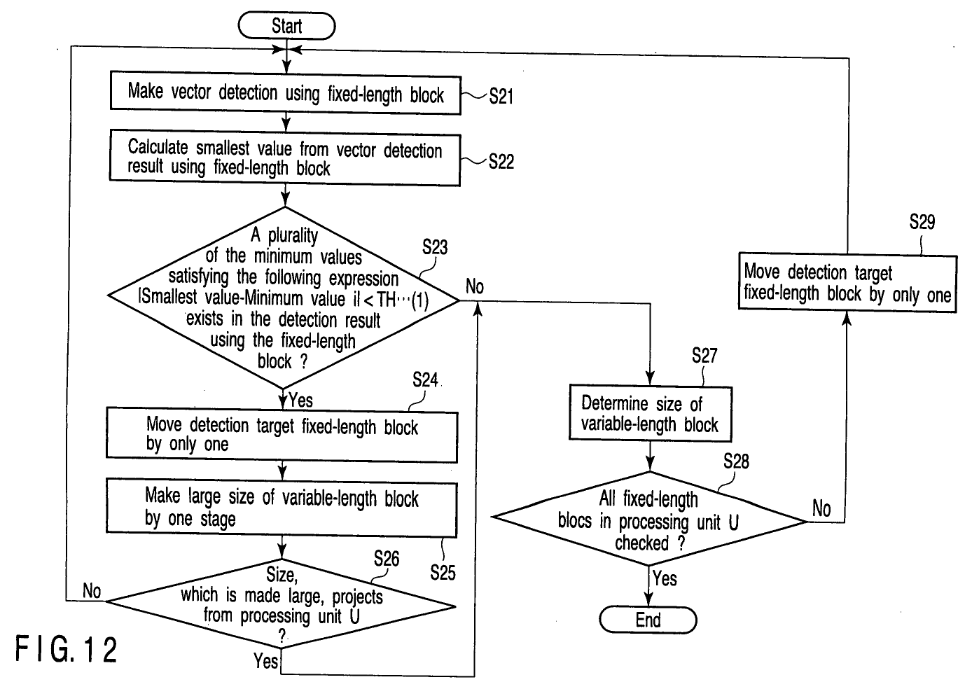

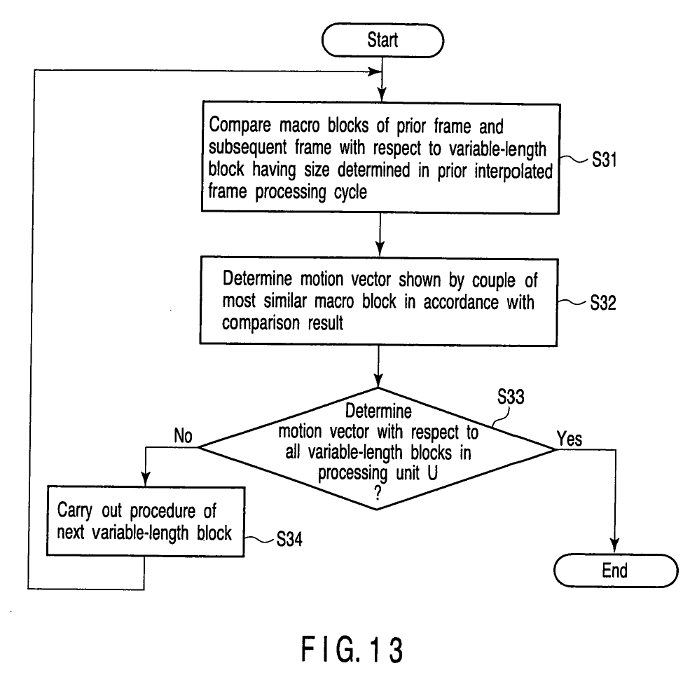

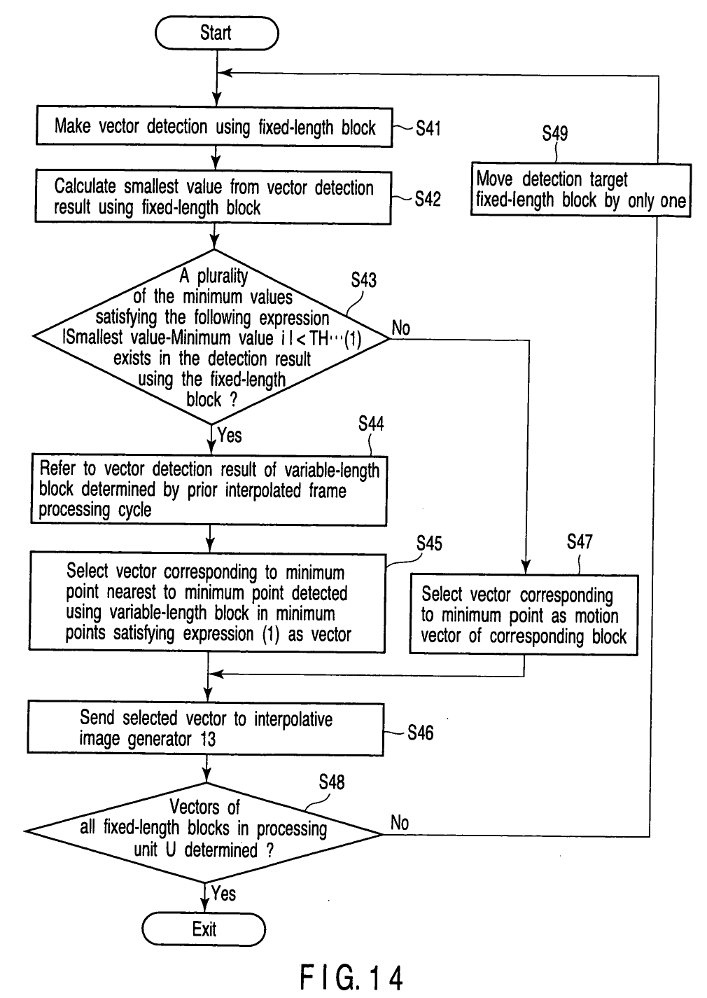

The foregoing three-stage operations will be detailedly explained below with reference to the following flowcharts. FIG. 12 is a flowchart to explain a first operation of the interpolative frame generating apparatus. FIG. 13 is a flowchart to explain a second operation of the interpolative frame generating apparatus. FIG. 14 is a flowchart to explain a third operation of the interpolative frame generating apparatus.

Each step of the flowcharts shown in FIGS. 12 to 14 is replaceable with a circuit block. Thus, the step of each flowchart is all defined as a block.

First Operation

The first operation, that is, the procedure of determining a variable-length block size will be explained below referring to the flowchart of FIG. 12.

The block size determination unit 25 of the interpolative frame generating apparatus 10 makes vector detection with respect to one processing unit frame image using a fixed-length block (S21). Then, the unit 25 calculates the smallest value from the vector detection result using the fixed-length block (step S22). Thereafter, the unit 25 determines whether or not a plurality of the minimum values satisfying the following expression (1) exists in the detection result using the fixed-length block (step S23).

|Smallest value−Minimum value i|<TH (1)

If a plurality of the minimum values dose not exist, there is no need of providing a variable-length block. The procedure proceeds to step S27. Then, the block size determination unit 25 determines a size of the variable-length block as zero (using fixed-length block only) (step S27). It is determined whether or not all fixed-length blocks in the processing unit are checked (step S28). If all fixed-length blocks in the processing unit are checked, the procedure ends. Conversely, if the fixed-length block in the processing unit remains, a detection target fixed-length block is moved one block (step S29) to continue the procedure from step S21.

The block size determination unit 25 moves the detection target fixed-length block only one if a plurality of motion vector candidates exists in step S23 (step S24) to make large the size of the variable-length block by one stage (step S25). Then, the unit 25 determines whether or not the size, which is made large, projects from the processing unit (step S26). If the size is sufficiently large, the procedure proceeds to step 27. Conversely, if the size is not large, the procedure returns to step S21 to continue the procedures after that.

The foregoing procedure is continued, and thereby, the method described before, that is, the method of detecting a periodical repeating pattern width is provided. According to the method, “area where some motion vector candidates are generated” is detected, and based on the width of the detected area, the size of the variable-length block (large block) is determined.

To give one example, the result of the “Size of area where some motion vector candidates are generated”≈ “Size of variable-length block (large block)” is obtained.

Preferably, “Area where some motion vector candidates are generated” ≈“Size of variable-length block (large block)”+a (constant) is set. However, the present invention is not limited to these relationships.

Second Operation

The second operation, that is, the procedure of determining a motion vector of a variable-length block will be explained referring to the flowchart of FIG. 13.

The variable-length block processing unit 24 acquires a size of the operation result determined according to the operation of the prior interpolated frame processing cycle as shown in the flowchart of FIG. 13. Then, the unit 24 compares macroblocks of the prior frame and the subsequent frame with respect to a variable-length block correspond to the determined size (step S31). The variable-length block processing unit 24 determines a motion block shown by a couple of the most similar macroblocks in accordance with the foregoing comparison result (step S32).

The variable-length block processing unit 24 repeats the procedures of steps S31 to S34 until a motion vector is determined with respect to all variable-length blocks in the processing unit.

Third Operation

The third operation, that is, the procedure of determining a motion vector of a fixed-length block will be explained referring to the flowchart of FIG. 14.

The fixed-length block processing unit 21 detects a vector using a fixed-length block as shown in the flowchart of FIG. 14 (step S41). The unit 21 calculates the smallest value from the vector detection result using the fixed-length block (step S42).

Then, the fixed-length block processing unit 21 determines whether or not a plurality of the minimum values satisfying the following expression (1) exists in the detection result using the fixed-length block (step S43).

|Smallest value−Minimum value i|<TH (1)

If a plurality of the smallest values dose not exist, a vector corresponding to the detected smallest value is selected as a motion vector of the block, and then, the procedure ends (step 47). Conversely, if a plurality of the smallest values exists, the selector 21 of the fixed-length block processing unit 23 refers to the vector detection result of the variable-length block, that is, the operation result of the prior interpolated frame processing cycle (step S44). Then, the selector 21 selects a vector corresponding to the minimum point nearest to the minimum point detected using the variable-length vector in the minimum point satisfying the expression (1) as motion vector of the block in (step S45). Thereafter, the selector 21 sends the selected vector to the interpolative image generator 13 (step S46).

The fixed-length block processing unit 21 determines whether or not the vectors of all fixed-length blocks in the processing unit are determined (step S48). If the vector is not determined with respect to all fixed-length blocks, the target fixed-length block is moved by one only (step S49), and thereafter, the procedures from steps S41 to S48 are repeated.

As described above, the foregoing procedures are carried out, and thereby, the size of the large block is flexibly variable with respect to an image including a periodical repeating pattern. In addition, it is possible to detect a motion vector having high accuracy corresponding to the image pattern. The operation result used for the operation is used for the prior interpolated frame processing cycle; therefore, the required total buffer amount is reduced.

### OTHER EMBODIMENT

An interpolated frame generated based on the operation result of the foregoing first to third operations of FIG. 7 may not be necessarily the same interpolated frame. In other words, the first and second operations are used for generating a certain interpolated frame while the third operation is used for generating another interpolated frame. The foregoing configuration is provided, and thereby, it is possible to reduce a motion vector detection error of the large block as time elapses.

The first operation of FIG. 7 may be omitted. In other words, the variable-length block different from the fixed-length block (small block) has a previously given fixed size. In this case, there is no need of determining the size in the first operation. Thus, preferably, the large block larger than the fixed-length block is prepared and used one kind or more. In this case, the embodiment having features of the present invention can be realized by the second and third operations of FIG. 7.

In FIG. 3, there are shown variable-length blocks formed by connecting the fixed-length blocks in the horizontal and vertical directions. However, it is preferable to form a variable-length block by connecting the fixed-length blocks in the horizontal direction only and in the vertical direction only.

The foregoing fixed-length block (small block) and variable-length block (large block) have two-stage size; however, these blocks may have three-stage or more size.

According to the features of the embodiment, the size of the large block is properly variable with respect to an image including a periodical repeating pattern. Thus, it is possible to detect a motion vector having high accuracy corresponding to the pattern, and to reduce the total buffer required for the detection.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An interpolative frame generating apparatus for generating an interpolated frame image inserted between continuous frame images, comprising:
a first operation unit configured to perform block matching processing with respect to a first block having a fixed size between the continuous frame images, and based on the result, calculate a size of a second block larger than the first block;
a second operation unit configured to perform block matching processing between the continuous frame images using the second block in accordance with the size calculated by the first operation unit in a prior interpolated frame processing cycle to calculate a motion vector;
a third operation unit configured to output a motion vector when one motion vector is detected based on the result of performing block matching processing with respect to the first block, and select and output one motion vector candidate from a plurality of motion vector candidates based on the motion vector obtained related to the second block in the prior interpolated frame processing cycle when a plurality of motion vector candidates is detected; and
a generator configured to generate an interpolated frame image based on the motion vector output by the third operation unit.

2. The apparatus according to claim 1, wherein block matching processing is performed with respect to the first block; as a result, when a plurality of motion vector candidates is detected, the first operation unit connects the first blocks to generate the second block.

3. The apparatus according to claim 2, wherein the connecting direction when the first operation unit connects the first blocks to generate the second block is either of horizontal and vertical direction.

4. The apparatus according to claim 2, wherein the connecting direction when the first operation unit connects the first blocks to generate the second block is both of horizontal and vertical direction.

5. The apparatus according to claim 1, wherein the first operation unit calculates a plurality of different sizes of the second block.

6. The apparatus according to claim 1, wherein at least two operation results of the first to third operation results by the first to third operation units are used for generating mutually different interpolated frames.

7. An interpolative frame generating apparatus for generating an interpolated frame image inserted between continuous frame images, comprising:
a first operation unit configured to perform block matching processing between the continuous frame images with respect to a second block having a size larger than a first block, which is the minimum unit of the block matching processing to calculate a motion vector;
a second operation unit configured to output a motion vector when one motion vector is detected based on the result of performing block matching processing with respect to the first block, and select and output one motion vector candidate from a plurality of motion vector candidates based on the motion vector obtained related to the second block in the prior interpolated frame processing cycle when a plurality of motion vector candidates is detected; and
a generator configured to generate an interpolated frame image based on the motion vector output by the second operation unit.

8. An interpolative frame generating method of generating an interpolated frame image inserted between continuous frame images, comprising:
performing block matching processing with respect to a first block having a fixed size between the continuous frame images, and based on the result, calculating a size of a second block larger than the first block;
performing block matching processing between frame images of an interpolated frame prior to the current interpolated frame using a second block in accordance with the size calculated in the prior interpolated frame processing cycle to calculate a motion vector;
performing block matching processing with respect to the first block between frame images, and as a result, when one motion vector is detected, outputting the motion vector;
selecting and outputting one motion vector candidate from a plurality of motion vector candidates based on the motion vector obtained related to the second block in the prior interpolated frame processing cycle when a plurality of motion vector candidates is detected; and
generating an interpolated frame image based on the output motion vector.

9. The method according to claim 8, wherein block matching processing is performed with respect to the first block; as a result, when a plurality of motion vector candidates is detected, the first blocks are connected to generate the second block.

10. The method according to claim 9, wherein the connecting direction when the first blocks are connected to generate the second block is either of horizontal and vertical direction.

11. The method according to claim 9, wherein the connecting direction when the first blocks are connected to generate the second block is both of horizontal and vertical direction.

12. The method according to claim 8, wherein at least two results of the first to third block matching processing results are used generating mutually different interpolated frames.

13. An interpolative frame generating method of generating an interpolated frame image inserted between continuous frame images, comprising:
performing block matching processing between the continuous frame images with respect to a second block having a size larger than a first block, which is the minimum unit of the block matching processing to calculate a motion vector;
outputting a motion vector when one motion vector is detected based on the result of performing block matching processing with respect to the first block, and selecting one motion vector candidate from a plurality of motion vector candidates based on the motion vector obtained related to the second block in the prior interpolated frame processing cycle when a plurality of motion vector candidates is detected; and
generating an interpolated frame image based on the selected motion vector.
